(19) United States
(12) Patent Application Publication
(10) Pub. No.: US 2019/0308876 A1
(43) Pub. Date: Oct. 10, 2019

(54) APPARATUS AND METHOD RELATED TO CARBON DIOXIDE REMOVAL

(71) Applicant: SABIC Global Technologies B.V., Bergen op Zoom (NL)

(72) Inventor: Labeeb Chaudhary Ahmed, Riyadh (SA)

(21) Appl. No.: 16/464,912

(22) PCT Filed: Nov. 29, 2017
(86) PCT No.: PCT/IB2017/057507

§ 371 Date: May 29, 2019

Related U.S. Application Data
(60) Provisional application No. 62/427,892, filed on Nov. 30, 2016.

(51) Int. Cl. C01B 3/52; C01B 3/34; B01D 53/14; B01D 53/18; B01J 23/889; B01D 53/00; C10G 2/00; C10K 1/00; C10K 1/10

(52) U.S. Cl. CPC C01B 3/52; C10G 2300/207; B01D 53/1406; B01D 53/1475; B01D 53/18; B01J 23/8892; B01D 53/002; C10G 2/332; C10K 1/005; C10K 1/10; C01B 2203/0233; C01B 2203/0261; C01B 2203/0415; C01B 2203/0475; C01B 2203/062; C01B 2203/1241; C01B 2203/148; C10G 2300/1022; C01B 3/34

(57) ABSTRACT

In accordance with the present invention, disclosed herein is an apparatus and method for removing CO₂ from products by using a first acid gas absorber and a second acid gas absorber, which are both a part of a single acid gas removal unit.

### CROSS-REFERENCE TO RELATED APPLICATIONS

This application claims priority to U.S. Application No. 62/427,892, filed on Nov. 30, 2016, which is incorporated herein by reference in its entirety.

### BACKGROUND

Syngas (mixtures of H₂ and CO) can be readily produced from a carbon source, such as either coal or methane (natural gas) by methods well known in the art and widely commercially practiced around the world. A number of well-known industrial processes use syngas for producing various hydrocarbons and oxygenated organic chemicals.

The Fischer-Tropsch catalytic process for catalytically producing hydrocarbons from syngas was initially discovered and developed in the 1920's, and was used in South Africa for many years to produce gasoline range hydrocarbons as automotive fuels. The catalysts typically comprised iron or cobalt supported on alumina or titania, and promoters were sometimes used with cobalt catalysts to improve various aspects of catalytic performance. The products were typically gasoline-range hydrocarbon liquids having six or more carbon atoms, along with other heavier hydrocarbon products.

Today lower molecular weight C2-C4 hydrocarbons are desired and can be obtained from syngas via the Fischer-Tropsch catalytic process.

Carbon dioxide (CO₂), an unwanted byproduct, is produced both in the process of producing syngas from a carbon source, such as natural gas, and also in the process of converting syngas to a hydrocarbon product, for example, a hydrocarbon product comprising C2-C4 hydrocarbons. The CO₂ should be removed from the hydrocarbon product before the hydrocarbon product can be further purified cryogenically.

Accordingly, there remains a long-term market need for a new and improved apparatus and method for removing CO₂ throughout the process of converting a carbon source, such as natural gas, to syngas, and, in turn, convert the syngas to a hydrocarbon product, for example, a hydrocarbon product comprising C2-C4 hydrocarbons.

Accordingly, an apparatus and method useful for the removal of CO₂ in the process of converting a carbon source, such as natural gas, to syngas, and, in turn, convert the syngas to a hydrocarbon product, for example, a hydrocarbon product comprising C2-C4 hydrocarbons, are described herein.

### SUMMARY OF THE INVENTION

Disclosed herein is an apparatus comprising: a) a syngas generation unit for converting a carbon source to syngas and a reactor for converting syngas to hydrocarbons; and b) an acid gas removal unit comprising a first acid gas absorber, a second acid gas absorber, and an acid gas stripper, wherein the syngas generation unit is in upstream fluid communication with the first acid gas absorber and the reactor is in downstream fluid communication with the first acid gas absorber and in upstream fluid communication with the second acid gas absorber, wherein the first acid gas absorber and the second gas absorber are both in upstream fluid communication with the acid gas stripper.

Also disclosed herein is a method comprising the steps of: a) converting a carbon source to a first product comprising syngas and CO₂; b) removing at least a portion of the CO₂ from the first product in a first acid gas absorber present in an acid gas removal unit, thereby producing a second product comprising syngas, c) converting the second product comprising syngas to a third product comprising hydrocarbon product and CO₂; d) removing at least a portion of the CO₂ from the third product in a second acid gas absorber present in the acid gas removal unit; e) stripping the removed CO₂ from the first product in an acid gas stripper; and f) stripping the removed CO₂ from the third product in the acid gas stripper.

Additional advantages will be set forth in part in the description which follows, and in part will be obvious from the description, or can be learned by practice of the aspects described below. The advantages described below will be realized and attained by means of the chemical compositions, methods, and combinations thereof particularly pointed out in the appended claims. It is to be understood that both the foregoing general description and the following detailed description are exemplary and explanatory only and are not restrictive of the invention, as claimed.

### DESCRIPTION OF THE FIGURES

The accompanying FIGURES, which are incorporated in and constitute a part of this specification, illustrate several aspects, and together with the description, serve to explain the principles of the invention.

FIG. 1 shows a flow diagram of an apparatus and a method described herein.

The present invention can be understood more readily by reference to the following detailed description of the invention.

### DETAILED DESCRIPTION

Disclosed herein are materials, compounds, compositions, and components that can be used for, can be used in conjunction with, can be used in preparation for, or are products of the disclosed method and compositions. It is to be understood that when combinations, subsets, interactions, groups, etc. of these materials are disclosed that while specific reference of each various individual and collective combinations and permutation of these compounds cannot be explicitly disclosed, each is specifically contemplated and described herein. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

All publications mentioned herein are incorporated herein by reference to disclose and describe the methods and/or materials in connection with which the publications are cited.

### 1. Definitions

In this specification and in the claims which follow, reference will be made to a number of terms which shall be defined to have the following meanings:

As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a.” “an” and “the” include plural referents unless the context clearly dictates otherwise. Thus, for example, reference to “a hydrocarbon” includes mixtures of two or more hydrocarbons.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about.” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The terms “first,” “first acid gas absorber.” “second,” “second acid gas absorber,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight of component Y, X and Y are present at a weight ratio of 2:5, and are present in such a ratio regardless of whether additional components are contained in the compound.

A weight percent (“wt %”) of a component, unless specifically stated to the contrary, is based on the total weight of the formulation or composition in which the component is included. For example, if a particular element or component in a composition or article is said to have about 80% by weight, it is understood that this percentage is relative to a total compositional percentage of 100% by weight.

As used herein, the terms “syngas” or “synthesis gas” are used interchangeably herein.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

### 2. Apparatus

In a syngas-to-olefin process, CO₂ is produced at two different places in the process: 1) CO₂ is produced in the syngas generation unit, which main purpose is to produce syngas from a carbon source, and 2) CO₂ is produced in the reactor when the syngas is catalytically converted to hydrocarbons. About 70% of the total amount of CO₂ produced in this process comes from the process performed in the syngas generation unit and about 30% from the process performed in the reactor. It is desired that all of the CO₂ be removed from product gas before cryogenic separation of the final products can be performed to purify the hydrocarbons.

In a conventional apparatus and method only one acid gas removal unit is used to remove the CO₂ to save on capital cost. However, in a conventional apparatus and method the CO₂ removal is all done after the production of the hydrocarbons in the reactor. Thus, the CO₂ that is produced in the syngas generation unit is transferred to the reactor. There are several disadvantages of this method, including 1) expansion and compression of gas is needed at several stages during the process; 2) high compressor duty is required because of the volume of gas that is processed; 3) a high utility consumption is needed during the reactor process; and 4) large equipment is needed due to the high volume of gas, including the CO₂, that is processed.

An alternative arrangement is the use of two acid gas removal units, one after the syngas generation unit, and the other after the reactor. While this arrangement removes the CO₂ generated during the Fischer Tropsch process, it is costly and inefficient.

The apparatus and method disclosed herein overcomes these shortcomings of the conventional apparatus and method. The disclosed apparatus and method removes CO₂ at two stages using at least two acid gas absorbers that are a part of a single acid gas removal unit. The CO₂ that is produced during the production of syngas in the syngas generation unit is first removed in a first acid gas absorber prior to entering the reactor. The CO₂ that is produced in the reactor is removed by a second acid gas absorber. Both the first acid gas absorber and the second acid gas absorber are in fluid communication with the same acid gas stripper. The first acid gas absorber, the second acid gas absorber, and the acid gas stripper are a part of the same acid gas removal unit.

Accordingly, disclosed herein is an apparatus comprising: a) a syngas generation unit for converting a carbon source to syngas and a reactor for converting syngas to hydrocarbons; and b) an acid gas removal unit comprising a first acid gas absorber, a second acid gas absorber, and an acid gas stripper, wherein the syngas generation unit is in upstream fluid communication with the first acid gas absorber and the reactor is in downstream fluid communication with the first acid gas absorber and in upstream fluid communication with the second acid gas absorber, wherein the first acid gas absorber and the second gas absorber are both in upstream fluid communication with the acid gas stripper.

In one aspect, the apparatus comprises a single acid gas removal unit and does not comprise two or more acid gas removal units. The acid gas removal unit does not comprise the syngas generation unit or the reactor described herein.

The syngas generation unit is configured to receive a carbon source, for example, natural gas, that can be converted to syngas in the syngas generation unit. It is understood that the syngas can be generated from a variety of different materials that contain carbon. In some aspects, the syngas can be generated from biomass, plastics, coal, municipal waste, natural gas, or any combination thereof. In yet other aspects, the syngas can be generated from a fuel comprising methane. In some other aspects, the syngas generation from the fuel comprising methane can be based on steam reforming, autothermal reforming, or a partial oxidation, or any combination thereof. Accordingly, the syngas generation unit can be a steam syngas generation unit, an autothermal syngas generation unit, or a partial oxidation syngas generation unit. In some aspects, the syngas is generated by steam reforming. In these aspects, steam methane (natural gas) reforming uses an external source of hot gas to heat tubes in which a catalytic reaction takes place that converts steam and methane into a gas comprising hydrogen and carbon monoxide. In other aspects, the syngas is generated by autothermal reforming. In these aspects, methane is partially oxidized in a presence of oxygen and carbon dioxide or steam. In aspects where oxygen and carbon dioxide are used to generate syngas from methane, the hydrogen and carbon monoxide can be produced in a ratio of 1 to 1. In some aspects, where oxygen and steam are utilized, the hydrogen and carbon monoxide can be produced in a ratio of 2.5 to 1. In some other aspects, the syngas is generated by a partial oxidation. In these other aspects, a substoichiometric fuel-air mixture is partially combusted in a syngas generation unit, creating a hydrogen-rich syngas. In a certain aspect, the partial oxidation can comprise a thermal partial oxidation and catalytic partial oxidation. In some aspects, the thermal partial oxidation is dependent on the air-fuel ratio and proceed at temperatures of 1,200° C. or higher. In yet other aspects, the catalytic partial oxidation use of a catalyst allows reduction of the required temperature to about 800° C. to 900° C. It is further understood that the choice of a reforming technique can depend on the sulfur content of the fuel being used. The catalytic partial oxidation can be employed if the sulfur content is below 50 ppm. A higher sulfur content can poison the catalyst, and thus, other reforming techniques can be utilized.

The product that is generated in the syngas generation unit also contains CO₂. Thus, the product that exits the syngas generation unit comprises at least syngas and CO₂. In one aspect, the product that exits the syngas generation unit comprises up to 20 wt % of CO₂. For example, the product that exits the syngas generation unit can comprise from 1 wt % to 20 wt % of CO₂, such as, from 5 wt % to 15 wt % of CO₂.

The syngas that that is produced in the syngas generation unit can have a H₂/CO molar ratio from about 0.5 to about 4. In some exemplary aspects, the H₂/CO molar ratio can be from about 1.0 to about 3.0. In other exemplary aspects, the H₂/CO molar ratio can be from about 1.5 to about 3.0, or in yet further exemplary aspects, the H₂/CO molar ratio can be from about 1.5 to about 2.5. It will be appreciated that the H₂/CO molar ratio can control the selectivity of the hydrocarbons that are being produced in the reactor where syngas is converted to hydrocarbons. The H₂ and CO (i.e. syngas) are catalytically reacted in the reactor downstream.

The product that exits the syngas generation unit and comprises at least syngas and CO₂ enters the acid gas removal unit for removal of at least a portion of the CO₂ that is present in the product. In one aspect, the apparatus consists of one acid gas removal unit.

The acid gas removal unit comprises a first acid gas absorber, a second acid gas absorber, and an acid gas stripper, wherein the syngas generation unit is in upstream fluid communication with the first acid gas absorber and the reactor is in downstream fluid communication with the first acid gas absorber and in upstream fluid communication with the second acid gas absorber, wherein the first acid gas absorber and the second gas absorber is in upstream fluid communication with the acid gas stripper.

The product that exits the syngas generation unit and comprises at least syngas and CO₂ enters the first acid gas absorber in the acid gas removal unit for removal of at least a portion of the CO₂ that is present in the product. In one aspect, the first acid gas absorber can be a first CO₂ absorber.

The purified product comprising syngas exits the first acid gas absorber and the acid gas removal unit and enters into the reactor. In one aspect, the reactor can be a Fischer-Tropsch reactor. Isothermal and/or adiabatic fixed bed reactors can be used as a Fischer-Tropsch reactor, which can carry out the Fischer-Tropsch process. The Fischer-Tropsch reactor can comprise a catalyst, such as, for example, one or more Fischer-Tropsch catalysts. Fischer-Tropsch catalysts are known in the art and can, for example, be Fe based catalysts and/or Co based catalysts and/or Ru based catalysts. In one aspect, the reactor comprises a Co/Mn catalyst or a Co/Mo catalyst, or a combination thereof. For example, U.S. Pat. No. 9,416,067 discloses a promoted Co/Mn catalyst for use in a Fischer-Tropsch process, which is hereby incorporated in its entirety, specifically for its disclosure of a promoted Co/Mn catalyst. For example, U.S. Pat. No. 9,381,499 discloses a supported Co/Mo catalyst for use in a Fischer-Tropsch process, which is hereby incorporated in its entirety, specifically for its disclosure of a supported Co/Mo catalyst.

The reactor converts the syngas to a hydrocarbon product in the presence of a catalyst. This process also produces CO₂. Thus, the hydrocarbon product that exits the reactor comprises at least hydrocarbon product and CO₂. In one aspect, the hydrocarbon product that exits the reactor comprises up to 20 wt % of CO₂. For example, the product that exits the reactor can comprise from 1 wt % to 20 wt % of CO₂, such as, from 5 wt % to 15 wt % of CO₂. In one aspect, the hydrocarbon product can further comprise water or unreacted syngas or a combination thereof.

In one aspect, the apparatus further comprises a compressor that is downstream from the reactor and upstream from the second acid gas absorber. The hydrocarbon product that exits the reactor and comprises at least hydrocarbons and CO₂ is compressed in the compressor. The compressed hydrocarbon product then enters into a condesator. Accordingly, in one aspect, the apparatus further comprises a condenser that is downstream from the compressor and upstream from the second acid gas absorber.

The condenser removes condensate (water) from the hydrocarbon product.

An advantage with the apparatus disclosed herein is that only one compressor is used upstream from the acid gas stripper. In one aspect, the apparatus does not comprise a compressor that is downstream from the syngas generation unit and upstream from the reactor. In another aspect, the apparatus consist of one compressor upstream of the acid gas stripper. For example, the apparatus can consist of one compressor upstream of the acid gas stripper and a second compressor downstream of the acid gas stripper.

An acid gas absorber, such as a first or second acid gas absorber, can absorb CO₂ by reacting CO₂ with a suitable solvent. This reaction can then be reversed in the acid gas stripper to separate release the CO₂ from the solvent, which solvent can then be reused in an acid gas absorber to further capture CO₂ in the same manner.

In one aspect, the acid gas stripper has a stripped CO₂ effluent that is in fluid communication with the syngas generation unit. As such, CO₂ that has been removed from the first and/or third product can be recycled to the syngas generation unit for reuse in the production of syngas.

The use of this absorption and stripping process with aqueous solvents such as alkanolamines and promoted potassium carbonate is known in the art. For example, CO₂ can be removed from flue gas, natural gas, hydrogen, synthesis gas, and other gases as descried in U.S. Pat. Nos. 4,477,419 and 4,152,217, each of which is incorporated herein by reference, in particular for their disclosure of carbon dioxide absorption. In one aspect, an alkanolamine can be used in the absorption/stripping process. For example, an aqueous solution of monoethanolamine (MEA) or diethanolamine (DEA) can be used. In another example, solvent blends can be use, such as, for example, a blend of a methyldiethanolamine (MDEA) solution promoted by piperazine or other secondary amines. Also, potassium carbonate solvents can be promoted by DEA or other reactive amines.

Gas absorption, in the acid gas absorber, such as a first or second acid gas absorber, is a process in which soluble components of a gas, for example CO₂, are dissolved in a liquid. Stripping, in the acid gas stripper, is the inverse of absorption, as it involves the transfer of volatile components from a liquid mixture into a gas. In a CO₂ removal process, absorption is used to remove CO₂ from a gas mixture, for example, a product comprising syngas and CO₂ or a hydrocarbon product comprising hydrocarbons and CO₂, and stripping is subsequently used to regenerate the solvent and capture the CO₂ contained in the solvent. Once CO₂ is removed from the gas or liquid mixture, for example, a product comprising syngas and CO₂ or a hydrocarbon product comprising hydrocarbons and CO₂, it can be captured and compressed for use in a number of applications, including sequestration, production of methanol, and tertiary oil recovery, or be recycled to the syngas generation unit in the conversion process of a carbon source to syngas.

A method of using absorption/stripping processes to remove CO₂ from gaseous streams is described in U.S. Pat. No. 4,384,875, which is incorporated herein by reference. In the absorption stage, the gas to be treated, containing the CO₂ to be removed, is placed in contact, in an absorption column, with the chosen absorbent under conditions of pressure and temperature such that the absorbent solution removes virtually all the CO₂. The purified gas exits the second acid gas absorber and is processed downstream as described herein. The absorbent solvent containing CO₂ (also called “rich solvent”) is drawn off and subjected to a stripping process to free it of the CO₂ and regenerate the solvent's absorbent properties (also called “lean solvent”).

The stripping process, which takes place in the acid gas stripper, of the rich solvent can be done at 100-120° C. at 1-2 atm to release the CO₂ and produce the lean solvent. The rich solvent feed can be preheated by cross-exchange with hot lean solvent product to within 5-30° C. of the acid stripper bottoms. The overhead vapor is cooled to condense water, which is returned as reflux to the countercurrent stripper. Once stripped the CO₂ can be compressed to 100-150 atm for further use as described herein.

In one aspect, the apparatus further comprises a cryogenic separation unit that is downstream from the second acid gas absorber. The cryogenic separation unit can comprise at least one distillation column. The cryogenic separation unit is used to separate unreacted syngas from methane and other light hydrocarbons, including methane, C2+ hydrocarbons, such as C2-C4 or C2-C7 hydrocarbons, that is present in the hydrocarbon product. The hydrocarbon product that enters into the cryogenic separation unit should not contain any CO₂, which is why the CO₂ is removed prior to the cryogenically separating hydrocarbons from unreacted syngas and other byproducts.

Optionally, in various aspects, the disclosed apparatus can be operated or configured on an industrial scale. In one aspect, the syngas generation unit, reactor, first acid gas absorber, second acid gas absorber, acid gas stripper, and cryogenic separation unit described herein can each be an industrial size reactor. For example, the syngas generation unit can be an industrial size syngas generation unit. In another example, the reactor can be an industrial size reactor. In yet another example, the first acid gas absorber can be an industrial size first acid gas absorber. In yet another example, the second acid gas absorber can be an industrial size second acid gas absorber. In yet another example, the acid gas stripper can be an industrial size acid gas stripper. In yet another example, the cryogenic separation unit can be an industrial size cryogenic separation unit.

The reactors, syngas generation units, and vessels disclosed herein can have a volume of at least about 1.000 liters, about 2,000 liters, about 5,000 liters, or about 20,000 liters. For example, the reactor can have a volume from about 1,000 liters to about 20,000 liters.

In one aspect, the syngas generation unit can have a volume of at least about 1,000 liters, about 2,000 liters, about 5,000 liters, or about 20,000 liters. For example, the syngas generation unit can have a volume from about 1,000 liters to about 20,000 liters.

In one aspect, the reactor can have a volume of at least about 1,000 liters, about 2,000 liters, about 5,000 liters, or about 20,000 liters. For example, the reactor can have a volume from about 1,000 liters to about 20,000 liters.

In one aspect, the first acid gas absorber can have a volume of at least about 1,000 liters, about 2,000 liters, about 5,000 liters, or about 20,000 liters. For example, the first acid gas absorber can have a volume from about 1.000 liters to about 20.000 liters.

In one aspect, the second acid gas absorber can have a volume of at least about 1,000 liters, about 2,000 liters, about 5,000 liters, or about 20,000 liters. For example, the second acid gas absorber can have a volume from about 1,000 liters to about 20,000 liters.

In one aspect, the acid gas stripper can have a volume of at least about 1,000 liters, about 2,000 liters, about 5,000 liters, or about 20,000 liters. For example, the acid gas stripper can have a volume from about 1.000 liters to about 20.000 liters.

In one aspect, the cryogenic separation unit can have a volume of at least about 1,000 liters, about 2.000 liters, about 5,000 liters, or about 20,000 liters. For example, cryogenic separation unit can have a volume from about 1,000 liter to about 20,000 liters.

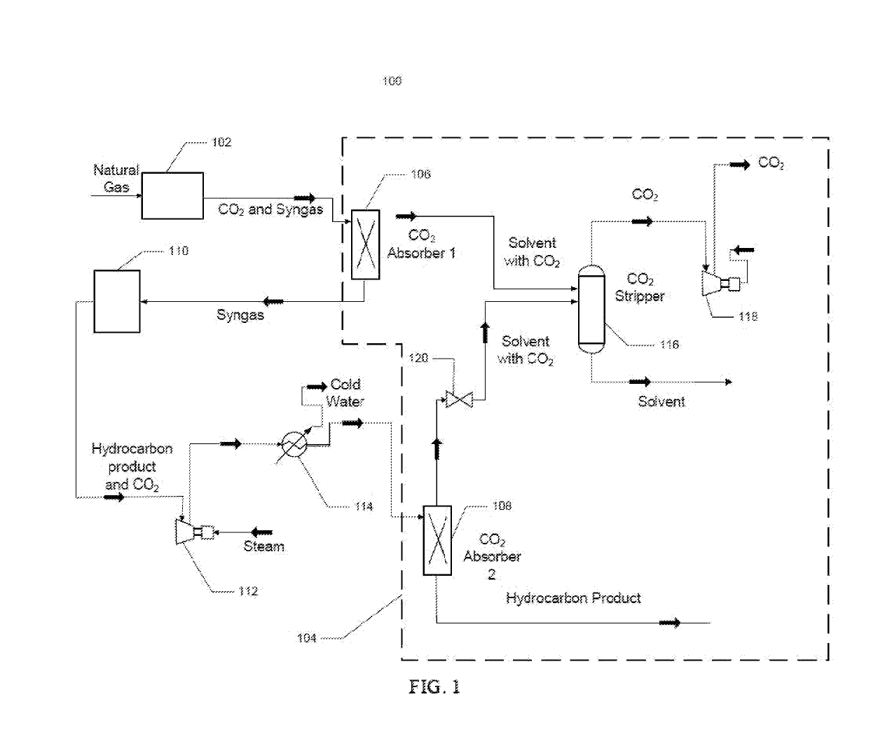

Now referring to FIG. 1, which shows a non-limiting exemplary aspect of the apparatus and method disclosed herein. FIG. 1 shows an apparatus (100). The apparatus has a syngas generation unit (102) for converting a carbon source to syngas. The first product that is generated in the syngas generation unit (102) comprises syngas and CO₂. The syngas generation unit (102) is in fluid communication with an acid gas removal unit (104). The acid gas removal unit (104) comprises a first acid gas absorber (106), a second acid gas absorber (108), and an acid gas stripper (116). The syngas generation unit (102) is in fluid upstream communication with the first acid gas absorber (106), which is a part of the acid gas removal unit (104). The first product from the syngas generation unit (102) that comprises syngas and CO₂ enters the first acid gas absorber (106), which absorbs at least a portion or all of the CO₂ into a solvent, thereby producing a second product comprising syngas. The solvent with the CO₂ (rich solvent) then enters into the acid gas stripper (116). The second product comprising syngas is transported to a reactor (110) that is in downstream fluid communication with the first acid gas absorber (106) and in upstream fluid communication with the second acid gas absorber (108). The reactor (110) catalytically converts at least a portion of the second product comprising syngas to a third product comprising hydrocarbon product and CO₂. The third product comprising hydrocarbon product and CO₂ is compressed in a compressor (112) that is downstream from the reactor (110). The compressed third product comprising hydrocarbon product and CO₂ further comprises water that is removed in a condenser (114) that is downstream from the compressor (112). The compressed third product then enters the second acid gas absorber (108), which absorbs at least a portion or all of the CO₂ into a solvent, thereby producing a fourth product comprising hydrocarbons. The solvent with the CO₂ (rich solvent) then enters into the acid gas stripper (116). The acid gas stripper (116) strips the CO₂ from the solvent to produce CO₂ and a solvent free of CO₂ (lean solvent). The CO₂ can be further compressed in a compressor (118) and recycled back to the syngas generation unit (102) to be used to generate syngas. The lean solvent can be recycled back to the first acid gas absorber (106) and/or the second acid gas absorber (108) for further absorption of CO₂. The forth product comprising hydrocarbons can be further transported to a cryogenic separation unit (not shown) for further purification.

### 3. Methods

Disclosed herein is a method comprising the steps of; a) converting a carbon source to a first product comprising syngas and CO₂; b) removing at least a portion of the CO₂ from the first product in a first acid gas absorber present in an acid gas removal unit, thereby producing a second product comprising syngas, c) converting the second product comprising syngas to a third product comprising hydrocarbon product and CO₂; d) removing at least a portion of the CO₂ from the third product in a second acid gas absorber present in the acid gas removal unit; e) stripping the removed CO₂ from the first product in an acid gas stripper; and f) stripping the removed CO₂ from the third product in the acid gas stripper. In one aspect, steps e) and f) can be performed simultaneously.

In one aspect, the method disclosed herein can be performed by the apparatus disclosed herein. In the exemplary aspect, the method disclosed herein is schematically illustrated in FIG. 1. In one aspect, the syngas is generated in a syngas generation unit 102. It is understood that the syngas can be generated from a variety of different sources that contain carbon. In some aspects, the syngas can be generated from biomass, plastics, coal, municipal waste, natural gas, or any combination thereof. In yet other aspects, the syngas can be generated from a fuel comprising methane. In some other aspects, the syngas generation from the fuel comprising methane can be based on steam reforming or autothermal reforming, or a partial oxidation, or any combination thereof.

The process of removing CO₂ from the first product in a first acid gas absorber is described elsewhere herein.

In one aspect, step (c further comprises contacting the second product comprising syngas with a Co/Mn catalyst, thereby converting the second product comprising syngas to the third product comprising hydrocarbon product and CO₂.

In one aspect, at least about 80% of the CO₂ in the first product is removed in the first acid gas absorber. For example, at least about 85%, 90%, 95%, 97%, or 99% of the CO₂ in the first product can be removed in the first acid gas absorber. In another example about 100% of the CO₂ in the first product is removed in the first acid gas absorber. For example, from about 80% to about 100% of the CO₂ in the first product can be removed in the first acid gas absorber.

In one aspect, at least about 80% of the CO₂ in the third product is removed in the second acid gas absorber. For example, at least about 85%, 90%, 95%, 97%, or 99% of the CO₂ in the third product can be removed in the second acid gas absorber. In another example about 100% of the CO₂ in the third product is removed in the second acid gas absorber. For example, from about 80% to about 100% of the CO₂ in the third product can be removed in the second acid gas absorber.

In certain aspects, the second product comprising syngas enters a reactor (110) wherein the third product comprising hydrocarbon product and CO₂ is catalytically produced. It is understood that the composition of syngas entering a reactor can vary significantly depending on the feedstock and the gasification process involved. In some aspects, the syngas composition can comprise from about 25 to about 60 wt. % carbon monoxide (CO), about 15 to about 50 wt. % hydrogen (H₂), from 0 to about 25 wt. % methane (CH₄), and from about 5 to about 45 wt. % carbon dioxide (CO₂). In yet other aspects, the syngas can further comprise nitrogen gas, water vapor, sulfur compounds such as for example, hydrogen sulfide (H₂S) and carbonyl sulfide (COS). In yet other aspects, the syngas can further comprise ammonia and other trace contaminants.

A reactor that targets the production of light olefins (C2-C8 olefins) is desired and such process can produce a significant amount of C2-C4 hydrocarbons in the third product. In some aspects, the third product comprises syngas, methane, C2-C4 hydrocarbons, and CO₂. In some exemplary aspects, the third product can comprise hydrogen, CO, CO₂, methane, ethylene, ethane, propylene, propane, butene, butane, mixture of nitrogen and argon, C2-C7 hydrocarbons, or any combination thereof. An exemplary non-limiting composition of the third product is shown in Table 1. The values shown in Table 1 were simulated using Aspen HYSYS V8.4. The values in Table 1 of the third product were calculated after removal of CO₂ and upgrade of C4-C9 hydrocarbons (olefins) via a catalytic conversion unit before being integrated with the remainder of the apparatus disclosed herein.

TABLE 1

| Third Product Components | Wt. % |
|---|---|
| CO | 40-55 |
| H₂ | 8-12 |
| Methane | 7-11 |
| C2-C7 Olefins/paraffin's | 21-30 |

In one aspect, the method further comprises recycling the stripped CO₂ back to the syngas generation unit. In one aspect, the method further comprises compressing the stripped CO₂ before recycling the stripped CO₂ back to the syngas generation unit. The recycled CO₂ can be used to produce new syngas.

In one aspect, the method further comprises compressing the third product in a compressor prior to removing at least a portion of the CO₂ from the third product. The compressed third product can further enter a condenser to remove condensate from the third product. Thus, the third product comprises less water after condensate has been removed.

In one aspect, step e) comprises stripping the removed CO₂ in the first product by separating the removed CO₂ from a solvent and further comprises the step of recycling the solvent to the first acid gas absorber or the second acid gas absorber; and/or wherein step f) comprises stripping the removed CO₂ in the third product by separating the removed CO₂ from a solvent and further comprises the step of recycling the solvent to the first acid gas absorber or the second acid gas absorber. For example, the method can further comprise the step of recycling the solvent to the first acid gas absorber. In another example, the method can further comprise the step of recycling the solvent to the second acid gas absorber.

In one aspect, the method further comprises after step d) purifying the third product in a cryogenic separation process. The cryogenic separation process is described elsewhere herein.

The apparatus and method disclosed herein have several benefits, including a lower capital cost, decrease in volumetric flow of gases to the reactor, decrease in compressor duty, and decrease in steam consumption. These benefits are due to the use of a single acid gas removal unit having two acid gas absorbers, and to the removal of the CO₂ produced in the syngas generation unit prior to the syngas entering the reactor.

### 4. Aspects

In view of the described catalyst and catalyst compositions and methods and variations thereof, herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: An apparatus comprising: a) a syngas generation unit for converting a carbon source to syngas and a reactor for converting syngas to hydrocarbons; and b) an acid gas removal unit comprising a first acid gas absorber, a second acid gas absorber, and an acid gas stripper, wherein the syngas generation unit is in upstream fluid communication with the first acid gas absorber and the reactor is in downstream fluid communication with the first acid gas absorber and in upstream fluid communication with the second acid gas absorber, wherein the first acid gas absorber and the second gas absorber are both in upstream fluid communication with the acid gas stripper.

Aspect 2: The apparatus of aspect 1, wherein the acid gas stripper has a stripped CO₂ effluent that is in fluid communication with the syngas generation unit.

Aspect 3: The apparatus of aspects 1 or 2, wherein the apparatus further comprises a compressor that is downstream from the reactor and upstream from the second acid gas absorber.

Aspect 4: The apparatus of aspect 3, wherein the apparatus further comprises a condenser that is downstream from the compressor and upstream from the second acid gas absorber.

Aspect 5: The apparatus of any one of aspects 1-4, wherein the apparatus does not comprise a compressor that is downstream from the syngas generation unit and upstream from the reactor.

Aspect 6: The apparatus of any one of aspects 1-5, wherein the apparatus further comprises a compressor that is downstream from the acid gas stripper.

Aspect 7: The apparatus of any one of aspects 1-6, wherein the first acid gas absorber is a first CO₂ absorber.

Aspect 8: The apparatus of any one of aspects 1-7, wherein the second acid gas absorber is a second CO₂ absorber.

Aspect 9: The apparatus of any one of aspects 1-8, wherein the reactor comprises a Co/Mn catalyst or a Co/Mo catalyst or a combination thereof.

Aspect 10: The apparatus of any one of aspects 1-9, wherein the apparatus further comprises a cryogenic separation unit that is downstream from the second acid gas absorber.

Aspect 11: The apparatus of any one of aspects 1-10, wherein the apparatus comprises a single acid gas removal unit.

Aspect 12: A method comprising: a) converting a carbon source to a first product comprising syngas and CO₂; b) removing at least a portion of the CO₂ from the first product in a first acid gas absorber present in an acid gas removal unit, thereby producing a second product comprising syngas; c) converting the second product comprising syngas to a third product comprising a hydrocarbon product and CO₂; d) removing at least a portion of the CO₂ from the third product in a second acid gas absorber present in the acid gas removal unit; e) stripping the removed CO₂ from the first product in an acid gas stripper 1; and f) stripping the removed CO₂ from the third product in the same acid gas stripper 1.

Aspect 13: The method of aspect 12, wherein step (c further comprises contacting the second product comprising syngas with a Co/Mn catalyst, thereby converting the second product comprising syngas to the third product comprising hydrocarbon product and CO₂.

Aspect 14: The method of aspects 12 or 13, wherein the method further comprises recycling the stripped CO₂ back to the syngas generation unit.

Aspect 15: The method of aspect 14, wherein the method further comprises compressing the stripped CO₂ before recycling the stripped CO₂ back to the syngas generation unit.

Aspect 16: The method of any one of aspects 12-15, wherein the method further comprises compressing the third product in a compressor prior to removing at least a portion of the CO₂ from the third product.

Aspect 17: The method of aspect 16, wherein the method further comprises removing condensate from the third product after compressing the third product.

Aspect 18: The method of any one of aspects 12-17, wherein the method further comprises after step d) purifying the third product in a cryogenic separation process.

Aspect 19: The method of any one of aspects 12-18, wherein step e) comprises stripping the removed CO₂ in the first product by separating the removed CO₂ from a solvent and further comprises the step of recycling the solvent to the first acid gas absorber or the second acid gas absorber; and/or wherein step f) comprises stripping the removed CO₂ in the third product by separating the removed CO₂ from a solvent and further comprises the step of recycling the solvent to the first acid gas absorber or the second acid gas absorber.

Aspect 20: The method of any one of aspects 12-19, wherein at least 80% of the CO₂ in the first product is removed in the first acid gas absorber and/or wherein at least 80% of the CO₂ in the third product is removed in the second acid gas absorber.

### 5. Example

As described herein, the apparatus and method disclosed herein have several benefits, including a lower capital cost, decrease in volumetric flow of gases to the reactor, decrease in compressor duty, and decrease in steam consumption. These benefits are due to the use of a single acid gas removal unit having two acid gas absorbers, and to the removal of the CO₂ produced in the syngas generation unit prior to the syngas entering the reactor, and are demonstrated by results from Hysys calculations shown below.

Aspen Hysys calculations indicate that the disclosed apparatus and method theoretically have:
1. a 6.4% decrease in product gas compressor duty, resulting in lowered compressor cost;
2. a 12% decrease in mass flow rate to the reactor;
3. a 2.8% decrease in volumetric flow rate to the reactor;
4. a 2.9% decrease in non-reactive materials being present in the reactor; and
5. a decrease in steam consumption for the compressor turbine.

What is claimed is:

1. An apparatus comprising:
a) a syngas generation unit for converting a carbon source to syngas and a reactor for converting syngas to hydrocarbons; and
b) an acid gas removal unit comprising a first acid gas absorber, a second acid gas absorber, and an acid gas stripper, wherein the syngas generation unit is in upstream fluid communication with the first acid gas absorber and the reactor is in downstream fluid communication with the first acid gas absorber and in upstream fluid communication with the second acid gas absorber,
wherein the first acid gas absorber and the second gas absorber are both in upstream fluid communication with the acid gas stripper.

2. The apparatus of claim 1, wherein the acid gas stripper has a stripped CO₂ effluent that is in fluid communication with the syngas generation unit.

3. The apparatus of claim 1 wherein the apparatus further comprises a compressor that is downstream from the reactor and upstream from the second acid gas absorber.

4. The apparatus of claim 3, wherein the apparatus further comprises a condenser that is downstream from the compressor and upstream from the second acid gas absorber.

5. The apparatus of claim 1, wherein the apparatus does not comprise a compressor that is downstream from the syngas generation unit and upstream from the reactor.

6. The apparatus of claim 1, wherein the apparatus further comprises a compressor that is downstream from the acid gas stripper.

7. The apparatus of claim 1, wherein the first acid gas absorber is a first CO₂ absorber.

8. The apparatus of claim 1, wherein the second acid gas absorber is a second CO₂ absorber.

9. The apparatus of claim 1, wherein the reactor comprises a Co/Mn catalyst or a Co/Mo catalyst or a combination thereof.

10. The apparatus of claim 1, wherein the apparatus further comprises a cryogenic separation unit that is downstream from the second acid gas absorber.

11. The apparatus of claim 1, wherein the apparatus comprises a single acid gas removal unit.

12. A method comprising:
a) converting a carbon source to a first product comprising syngas and CO₂;
b) removing at least a portion of the CO₂ from the first product in a first acid gas absorber present in an acid gas removal unit, thereby producing a second product comprising syngas;
c) converting the second product comprising syngas to a third product comprising a hydrocarbon product and CO₂;
d) removing at least a portion of the CO₂ from the third product in a second acid gas absorber present in the acid gas removal unit;
e) stripping the removed CO₂ from the first product in an acid gas stripper; and
f) stripping the removed CO₂ from the third product in the same acid gas stripper.

13. The method of claim 12, wherein step (c further comprises contacting the second product comprising syngas with a Co/Mn catalyst, thereby converting the second product comprising syngas to the third product comprising hydrocarbon product and CO₂.

14. The method of claim 12, wherein the method further comprises recycling the stripped CO₂ back to the syngas generation unit.

15. The method of claim 14, wherein the method further comprises compressing the stripped CO₂ before recycling the stripped CO₂ back to the syngas generation unit.

16. The method of claim 12, wherein the method further comprises compressing the third product in a compressor prior to removing at least a portion of the CO₂ from the third product.

17. The method of claim 16, wherein the method further comprises removing condensate from the third product after compressing the third product.

18. The method of claim 12, wherein the method further comprises after step d) purifying the third product in a cryogenic separation process.

19. The method of claim 12, wherein step e) comprises stripping the removed CO₂ in the first product by separating the removed CO₂ from a solvent and further comprises the step of recycling the solvent to the first acid gas absorber or the second acid gas absorber; and/or wherein step f) comprises stripping the removed CO₂ in the third product by separating the removed CO₂ from a solvent and further comprises the step of recycling the solvent to the first acid gas absorber or the second acid gas absorber.

20. The method of claim 12, wherein at least 80% of the CO₂ in the first product is removed in the first acid gas absorber and/or wherein at least 80% of the CO₂ in the third product is removed in the second acid gas absorber.
